(19) United States
(12) Patent Application Publication
(10) Pub. No.: US 2012/0040116 A1
(43) Pub. Date: Feb. 16, 2012

(54) DEVICE HOUSING AND METHOD FOR MAKING THE SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); CONG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/150,355

(22) Filed: Jun. 1, 2011

(30) Foreign Application Priority Data
Aug. 16, 2010 (CN) 201010254314.6

(51) Int. Cl. B32B 9/00; B05D 5/06; B32B 1/02; H05H 1/24

(52) U.S. Cl. 428/34.6; 427/569; 427/160; 428/34.1; 428/35.7

(57) ABSTRACT

A device housing is provided. The device housing includes a substrate, and a photochromic coating formed on the substrate. The photochromic coating includes at least one of a silver chloride-cuprous chloride mixture, a silver bromide-cuprous bromide mixture, and a silver chloride-cuprous chloride-silver bromide-cuprous bromide mixture. A method for making the device housing is also described therein.

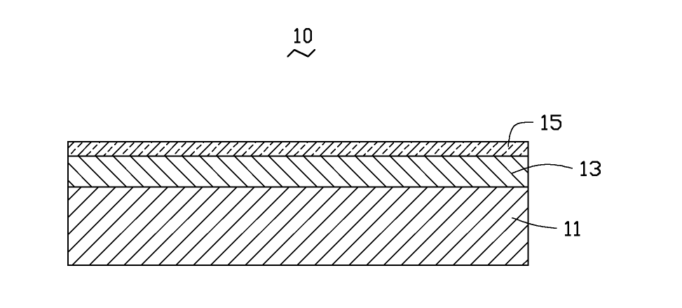

### BACKGROUND

1. Technical Field

The present disclosure relates to device housings, particularly to a device housing having a photochromic property and a method for making the device housing.

2. Description of Related Art

Many electronic device housings are coated with a photochromic coating. These photochromic coatings are commonly printed with an ink or painted with a paint that contains photochromic compounds. However, the printed or painted coatings are thick (commonly 2 μm-4 μm) and not very effective. Furthermore, the paint or ink may not be environmentally friendly.

Therefore, there is room for improvement within the art.

### BRIEF DESCRIPTION OF THE FIGURE

Many aspects of the device housing can be better understood with reference to the following FIGURE. The components in the FIGURE are not necessarily drawn to scale, the emphasis instead being placed upon clearly illustrating the principles of the device housing.

The FIGURE is a cross-sectional view of an exemplary embodiment of a device housing.

### DETAILED DESCRIPTION

The FIGURE shows a device housing 10 according to an exemplary embodiment. The device housing 10 includes a substrate 11, a photochromic coating 13 formed on a surface of the substrate 11, and a protective coating 15 formed on the photochromic coating 13.

The substrate 11 may be made of metal or glass or under certain circumstances plastic.

The photochromic coating 13 includes at least one of a silver chloride-cuprous chloride (AgCl—CuCl) mixture, a silver bromide-cuprous bromide (AgBr—CuBr) mixture, and a AgCl—CuCl—AgBr—CuBr mixture. Each mixture has a property of reversible color change. The CuCl or CuBr may have a mass percentage of about 10%-20% in the mixture of AgCl—CuCl or AgBr—CuBr, or the CuCl and CuBr may have a mass percentage of about 10%-20% in the mixture of AgCl—CuCl—AgBr—CuBr. The photochromic coating 13 may be formed by vacuum evaporation. The photochromic coating 13 has a thickness of about 500 nm-1500 nm, which is lower than the printed or painted photochromic coatings.

When irradiated, the AgCl or AgBr within the photochromic coating 13 may break down and generate Ag crystal particles, and the Ag crystal particles then change the color of the photochromic coating 13 from white to black. When the irradiation lessens or stops, the CuCl or CuBr within the photochromic coating 13 may catalyze the Ag crystal particles back to AgCl or AgBr, causing the photochromic coating 13 to revert its color back from black to white.

As mentioned above, the CuCl or CuBr acts as a color changing catalyst in the photochromic coating 13. The CuCl or CuBr contained in the photochromic coating 13 has a high photosensitivity, which makes the photochromic property of the photochromic coating 13 more effective.

The protective coating 15 may be a silica dioxide (SiO₂) optical coating formed by vacuum evaporation. The protective coating 15 is optically transparent and has a thickness of about 300 nm-500 nm. The protective coating 15 protects the photochromic coating 13 from abrasion. Since the protective coating 15 is an optically transparent coating, it does not affect the irradiation of the photochromic coating 13 or its photochromic property.

A method for making the device housing 10 may include the following steps:

The substrate 11 is provided for pre-treatment. The pre-treating process may include the step of cleaning the substrate 11 in an ultrasonic cleaning device (not shown) filled with ethanol or acetone.

The photochromic coating 13 is deposited on the pretreated substrate 11 by vacuum evaporation. Vacuum evaporation depositing the photochromic coating 13 is implemented in a plating chamber of a vacuum evaporative equipment (not shown). The substrate 11 is positioned in the plating chamber. The plating chamber is then evacuated to about 4.0×10⁻³ Pa. Compounds of AgCl and CuCl, compounds of AgBr and CuBr, or compounds of AgCl, CuCl, AgBr, and CuBr may be used as an evaporation target for the deposition. The CuCl or CuBr may have a mass percentage of about 10%-20% in the compounds of AgCl and CuCl or AgBr and CuBr, or the CuCl and CuBr may have a mass percentage of about 10%-20% in the compounds of AgCl, CuCl, AgBr, and CuBr. The evaporation target may be electron beam heated to evaporate and deposit on the substrate 11 to form the photochromic coating 13. The depositing rate of the photochromic coating 13 may be about 3 angstrom per second (Å/S)-10 Å/S. The inside of the plating chamber may be heated to about 50° C.-150° C. during the depositing process. Additionally, during the depositing process, the substrate 11 may be bombarded by plasma at a power of about 900 W-1500 W to enhance the bond between the photochromic coating 13 and the substrate 11. The plasma may be produced by a plasma producer.

It is to be understood that if the inside temperature of the plating chamber is lower than 100° C. during the depositing process, the substrate 11 can also be made of plastic.

The protective coating 15 is formed on the photochromic coating 13 by vacuum evaporation. The protective coating 15 is a transparent silica dioxide optical coating and has a thickness of about 300 nm-500 nm.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A device housing, comprising:
a substrate; and
a photochromic coating formed on the substrate, the photochromic coating containing at least one of a silver chloride-cuprous chloride mixture, a silver bromide-cuprous bromide mixture, and a silver chloride-cuprous chloride-silver bromide-cuprous bromide mixture.

2. The device housing as claimed in claim 1, wherein the cuprous chloride or the cuprous bromide has a mass percentage of about 10%-20% in the silver chloride-cuprous chloride mixture or the silver bromide-cuprous bromide mixture; the cuprous chloride and the cuprous bromide have a mass percentage of about 10%-20% in the silver chloride-cuprous chloride-silver bromide-cuprous bromide mixture.

3. The device housing as claimed in claim 1, wherein the photochromic coating has a thickness of about 500 nm-1500 nm.

4. The device housing as claimed in claim 1, wherein the photochromic coating is formed by vacuum evaporation deposition.

5. The device housing as claimed in claim 1, further comprising a protective coating formed on the photochromic coating.

6. The device housing as claimed in claim 5, wherein the protective coating is a transparent silica dioxide optical coating.

7. The device housing as claimed in claim 6, wherein the silica dioxide optical coating has a thickness of about 300 nm-500 nm.

8. The device housing as claimed in claim 1, wherein the substrate is made of metal, glass or plastic.

9. A method for making a device housing, comprising:
providing a substrate; and
forming a photochromic coating on the substrate by vacuum evaporation depositing, the photochromic coating containing at least one of a silver chloride-cuprous chloride mixture, a silver bromide-cuprous bromide mixture, and a silver chloride-cuprous chloride-silver bromide-cuprous bromide mixture.

10. The method as claimed in claim 9, wherein vacuum evaporation depositing the photochromic coating uses compounds of silver chloride and cuprous chloride or compounds of silver bromide and cuprous bromide or compounds of silver chloride, cuprous chloride, silver bromide, and cuprous bromide as an evaporation target, the evaporation target is electron beam heated; depositing the photochromic coating is at a depositing rate of about 3-10 angstrom per second.

11. The method as claimed in claim 10, wherein the substrate is striked by plasma at a power of about 900 W-1500 W during vacuum evaporation depositing the photochromic coating.

12. The method as claimed in claim 10, further comprising a step of vacuum evaporation depositing a protective coating on the photochromic coating.

13. The method as claimed in claim 12, wherein the protective coating is an optically transparent silica dioxide optical coating.

14. The method as claimed in claim 9, wherein the substrate is made of metal, glass or plastic.
